(19) United States
(12) Patent Application Publication
(10) Pub. No.: US 2017/0111710 A1
(43) Pub. Date: Apr. 20, 2017

(54) CONTENT SERVICE METHOD

(71) Applicant: SK Planet Co., Ltd., Seongnam-si (KR)

(72) Inventor: Sang Ho CHAE, Anyang-si (KR)

(21) Appl. No.: 15/392,919

(22) Filed: Dec. 28, 2016

Related U.S. Application Data
(63) Continuation of application No. 13/702,884, filed on Feb. 12, 2013.

(30) Foreign Application Priority Data
Jun. 10, 2010 (KR) 10-2010-0054939

(51) Int. Cl. H04N 21/81; H04N 21/84; H04N 21/239; H04N 21/472; H04N 21/4722; H04N 21/4788; H04N 21/858; H04N 21/235

(52) U.S. Cl. CPC H04N 21/8133; H04N 21/8586; H04N 21/84; H04N 21/2353; H04N 21/47217; H04N 21/47205; H04N 21/4722; H04N 21/4788; H04N 21/2393

(57) ABSTRACT

The present disclosure relates to a content service method, including at least obtaining tagging information about a content including at least one of section, wherein the tagging information includes identifier of a content, time information and location information of the at least one section, generating additional information of the content based on the obtained tagging information, and transmitting the additional information of the content to a terminal. The at least one section of the content is played out in the terminal based on the additional information.

### CROSS-REFERENCE TO RELATED APPLICATIONS

The present application is a continuation of U.S. patent application Ser. No. 13/702,884 filed Feb. 12, 2013, which is a National Stage Entry of International Patent Application No. PCT/KR2011/002854, filed Apr. 21, 2011, which is based on and claims priority to Korean Patent Application No. 10-2010-0054939, filed on Jun. 10, 2010. The disclosures of the above-listed applications are hereby incorporated by reference herein in their entirety.

### TECHNICAL FIELD

Exemplary embodiments of the present disclosure relate to a content service method, and to a content service method, a terminal device, a method of using a content service by a terminal device, a content service server, and a method of providing a content service by a content service server, which enable a user reproducing/displaying a video content to easily and freely input a user comment on an image area or a specific reproduction section of a specific scene, and automatically register/post a corresponding article to a web service based on tagging information according to the input user comment, thereby enabling the user to acquire additional comments, such as necessary replies/opinions, from a group of many unspecified intelligent users who use the web service, and which further generate/manage additional information on each video content based on the user comment on the specific image area or the specific reproduction section of the specific scene and additional comments on the user comment made by many unspecified users, thereby generating/managing more detail and various additional information on the video content.

### RELATED ART

According to the generalization of an environment in which a video can be reproduced through various types of mobile terminals, as well as a Personal Computer (PC), users can acquire desired video contents through various schemes and reproduce/watch the video contents anytime and anywhere.

In this respect, the users come to have specific desires of acquiring more various and detailed information, such as specific information on contents of a video, such as a place, a person, and an object appearing in the video, and opinions of other users, as well as technical information on the video which the users view.

Accordingly, in order to satisfy the specific desires of the users, a method of providing a video by tagging additional information to the video may be conceived.

However, an automatic object recognition/tagging method through a contour line extraction tool among existing tagging methods has a limitation in generalization due to a problem of a recognition rate. Further, a method in which a video is dominantly tagged and managed by a service operator among the existing tagging methods has a limitation in the activation due to high operation costs.

### DETAILED DESCRIPTION

### Technical Problem

Accordingly, an exemplary embodiment of the present disclosure provides a content service method in which when a user comment on a predetermined selected area designated in connection with a predetermined video content is input by a user in a terminal device for reproducing the predetermined video content, the terminal device generates tagging information on the video content based on the user comment, and when the terminal device provides the generated tagging information to a corresponding content service server, the content service server registers an article corresponding to the tagging information in at least one corresponding web service server based on the tagging information, so that a user reproducing/watching the video content can easily and freely input the user comment on the image area or a specific reproduction section of a specific scene and a corresponding article is automatically registered/posted to the web service based on the tagging information according to the input user comment, thereby enabling the user to acquire desired additional comments, such as responses and opinions, from a group of many unspecified intelligent users who use the web service.

Another exemplary embodiment of the present disclosure provides a terminal device and a method of using a content service by the terminal device, in which a predetermined video content is reproduced, and when a predetermined selected area in connection with the video content is designated according to an operation by a user and a user comment is input in connection with the selected area according to an operation by a user, tagging information on the video content is generated based on the user comment and the generated tagging information is provided to a content service server, thereby supporting an environment in which a user reproducing/watching the video content can easily and freely input the user comment on the image area or a specific reproduction section of a specific scene and a corresponding article is automatically registered/posted to the web service based on the tagging information according to the input user comment, so that the user can acquire desired additional comments, such as responses and opinions, from a group of many unspecified intelligent users who use the web service.

Yet another exemplary embodiment of the present disclosure provides a content service server and a method of providing a content service by the content service server, in which predetermined tagging information provided from an external terminal device is received and an article corresponding to the tagging information is registered in one or more corresponding web service servers based on the received tagging information, thereby supporting an environment in which a user reproducing/watching the video content can easily and freely input the user comment on the image area or a specific reproduction section of a specific scene and a corresponding article is automatically registered/posted to the web service based on the tagging information according to the input user comment, so that the user can acquire desired additional comments, such as responses and opinions, from a group of many unspecified intelligent users who use the web service.

### Technical Solution

In accordance with an embodiment of the present disclosure, there is provided a terminal device including: a user operation unit for an operation by a user; and a content controller for reproducing a predetermined video content, and generating tagging information on the video content based on a user comment when a predetermined selected area related to the video content is designated and the user comment on the selected area is input according to the operation by the user through the user operation unit and providing the generated tagging information to a corresponding content service server, wherein when the tagging information is received, the content service server registers an article corresponding to the tagging information in at least one corresponding web service server based on the received tagging information.

Preferably, the content controller may recognize a thumbnail image corresponding to a specific reproduction time of the video content or a captured image of a reproduced scene corresponding to the specific reproduction time of the video content selected according to the operation by the user through the user operation unit as the scene image, and provide a selected area designation User Interface (UI) for inducing designation of a specific image area of the scene image as the selected area or provides a selected area designation UI for inducing designation of a specific reproduction section of the video content as the selected area.

Preferably, when the selected area is designated according to the operation by the user through the user operation unit, the content controller may provide a comment input UI for inducing input of the user comment including at least one of a reply, a question, a relevant opinion, a comment, a relevant URL, and an advertisement in connection with the selected area, and provide a posting selection UI for inducing selection of posting of the user comment input through the comment input UI to a web service.

Preferably, when a web service posting request is selected through the posting selection UI and posting request information containing at least one of web service server information, log-in related information, and information on selection of publication or non-publication for at least one web service to which a request for posting of the user comment is made is input, the content controller may generate the tagging information on the video content based on the user comment and the posting request information.

Preferably, the content controller may generate the tagging information containing at least one of the user comment, information on the corresponding video content in which the user comment is input, scene image information including the reproduction time of the scene image in which the user comment is input, selected area information indicating the selected area designated in the scene image, selected area information indicating the selected area corresponding to the reproduction section in which the user comment is input, and the posting request information containing at least one of the information on the predetermined web service server, the log-in related information, and the information on the selection of the publication or non-publication, and provide the content service server with the generated tagging information.

In accordance with another embodiment of the present disclosure, there is provided a content service server including: an information receiver for receiving predetermined tagging information provided from an external terminal device; and an article controller for registering an article corresponding to the tagging information in one or more corresponding web service servers based on the tagging information received through the information receiver, wherein the article controller generates/manages article history/article relevant information on the article registered in connection with the tagging information for each user, updates the article history/article relevant information in connection with a corresponding user based on additional comment input information when the predetermined additional comment input information is received from the web service server in connection with the article registered in the web service server, and provides the article history/article relevant information in connection with the corresponding user to the terminal device when a terminal device corresponding to a predetermined user is connected or when an connected terminal device of the corresponding user is in an accessing state while updating the article history/article relevant information in connection with the predetermined user according to the reception of the additional comment input information and makes the terminal device display additional comment summary information according to the article history/article relevant information.

Preferably, the article controller may receive registration of posting request information containing at least one of web service server information, log-in related information, and information on selection of publication or non-publication for a web service to which a request for posting of a user comment contained in the tagging information is made in advance for each user, and store/manage the posting request information, and when the tagging information is received through the information receiver, the article controller may register the article corresponding to the tagging information in the one or more corresponding web service servers based on the posting request information of the corresponding user in connection with the received tagging information.

Preferably, when the tagging information is received through the information receiver, the article controller may extract/recognize posting request information containing at least one of web service server information, log-in related information, and information on selection of publication or non-publication for a web service to which a request for posting of a user comment contained in the tagging information is made from the received tagging information, and register the article corresponding to the tagging information in the one or more corresponding web service servers based on the posting request information.

Preferably, the article controller may access the one or more corresponding web service servers based on the posting request information, perform a log-in process by using the log-in relevant information, generate and register the article including at least one of the predetermined user comment contained in the tagging information, information on a corresponding video content in which the user comment is input, scene image information including a reproduction time corresponding to a scene image in which the user comment is input, and selected area information indicating a selected area designated in the scene image and indicating a selected area corresponding to a reproduction section in which the user comment is input, and set an item for the publication or the non-publication of an additional comment registered in connection with the registered article according to the information on the selection of the publication or non-publication.

Preferably, the content service server may further include an additional information controller for generating/managing additional information on the corresponding video content based on at least one of the tagging information and the additional comment input information received from the web service server in connection with the registered article.

In accordance with another embodiment of the present disclosure, there is provided a content service method including: when a user comment on a predetermined selected area designated in connection with a predetermined video content is input by a user in a terminal device for reproducing the predetermined video content, generating tagging information on the video content based on the user comment by the terminal device; providing the generated tagging information to a corresponding content service server by the terminal device; and registering an article corresponding to the tagging information in at least one corresponding web service server based on the tagging information by the content service server.

Preferably, the content service method may further include when an additional comment on the registered article is input, providing additional comment input information on the article to the content service server by the web service server.

In accordance with another embodiment of the present disclosure, there is provided a method of using a content service by a terminal device, the method including: reproducing a predetermined video content; when a predetermined selected area in connection with the video content is designated and a user comment is input in connection with the selected area according to an operation by a user, generating tagging information on the video content based on the user comment; and providing the tagging information to a corresponding content service server, wherein when the tagging information is received, the content service server registers an article corresponding to the tagging information in at least one corresponding web service server based on the received tagging information.

Preferably, the generating of the tagging information may include providing a comment input UI for inducing input of the user comment including at least one of a reply, a question, a relevant opinion, a comment, a relevant URL, and an advertisement in connection with the selected area when the selected area is designated according to the operation by the user; and providing a posting selection UI for inducing selection of posting of the user comment input through the comment input UI to a web service.

Preferably, the generating of the tagging information may include when a web service posting request is selected through the posting selection UI and posting request information containing at least one of web service server information, log-in related information, and information on selection of publication or non-publication for a web service to which a request for posting of the user comment is made is input, generating the tagging information on the video content based on the user comment and the posting request information.

In accordance with another embodiment of the present disclosure, there is provided a method of providing a content service by a content service server, the method including: receiving predetermined tagging information provided from an external terminal device; controlling an article by registering the article corresponding to the tagging information in one or more corresponding web service servers based on the received tagging information; generating/managing article history/article relevant information on the article registered in connection with the tagging information for each user; when predetermined additional comment input information is received from the web service server in connection with the article registered in the web service server, updating the article history/article relevant information in connection with a corresponding user based on the additional comment input information; and when a terminal device corresponding to a predetermined user is connected or when an connected terminal device of a predetermined user is in an accessing state while the article history/article relevant information in connection with the predetermined user according to the reception of the additional comment input information is updated, providing the article history/article relevant information corresponding to the predetermined user to the terminal device and making the terminal device to display additional comment summary information according to the article history/article relevant information.

Preferably, the method may further include managing registered information by receiving registration of posting request information containing at least one of web service server information, log-in related information, and information on selection of publication or non-publication for a web service to which a request for posting of a user comment contained in the tagging information is made in advance for each user, and storing/managing the posting request information, wherein controlling of the article includes registering the article corresponding to the tagging information in the one or more corresponding web service servers based on the posting request information of the corresponding user in connection with the received tagging information.

Preferably, the controlling of the article may include: extracting/recognizing posting request information containing at least one of web service server information, log-in related information, and information on selection of publication or non-publication for a web service to which a request for posting of a user comment contained in the tagging information is made from the received tagging information; and registering the article corresponding to the tagging information in the one or more corresponding web service servers based on the recognized posting request information.

Preferably, the controlling of the article may include: accessing the one or more corresponding web service servers based on the posting request information and performing a log-in process by using the log-in relevant information; generating and registering the article including at least one of the predetermined user comment contained in the tagging information, information on a corresponding video content in which the user comment is input, scene image information including a reproduction time corresponding to a scene image in which the user comment is input, selected area information indicating a selected area designated in the scene image, and selected area information indicating a selected area corresponding to a reproduction section in which the user comment is input; and setting an item for the publication or the non-publication of an additional comment registered in connection with the registered article according to the information on the selection of the publication or non-publication.

### Effect

According to the content service method of the present disclosure, a user reproducing/watching a video content can easily and freely input a user comment on an image area or a specific reproduction section of a specific scene and a corresponding article is automatically registered/posted to a web service based on the tagging information according to the input user comment, so that the user can acquire desired additional comments, such as responses and opinions, from a group of many unspecified intelligent users who use the web service. Further, the content service method can effectively generate/manage more detailed and various additional information on the video by generating/managing additional information on each video content based on user comments and additional comments on the user comments on an image region or a specific reproduction section of a specific scene by many unspecified users.

### BRIEF DESCRIPTION OF THE DRAWINGS

FIG. 1 is a diagram illustrating a control of a content service system according to an exemplary embodiment of the present disclosure.

FIG. 2 is a block diagram illustrating a control of a terminal device according to an exemplary embodiment of the present disclosure.

FIG. 3 is a block diagram illustrating a control of a content service server according to an exemplary embodiment of the present disclosure.

FIG. 4 is a flowchart illustrating a control flow of a content service method according to an exemplary embodiment of the present disclosure.

FIG. 5 is a flowchart illustrating a method of using a content service by a terminal device according to an exemplary embodiment of the present disclosure.

FIG. 6 is a flowchart illustrating a method of providing a content service by a content service server according to an exemplary embodiment of the present disclosure.

### BEST MODE

Hereinafter, exemplary embodiments of the present disclosure will be described with reference to the accompanying drawings.

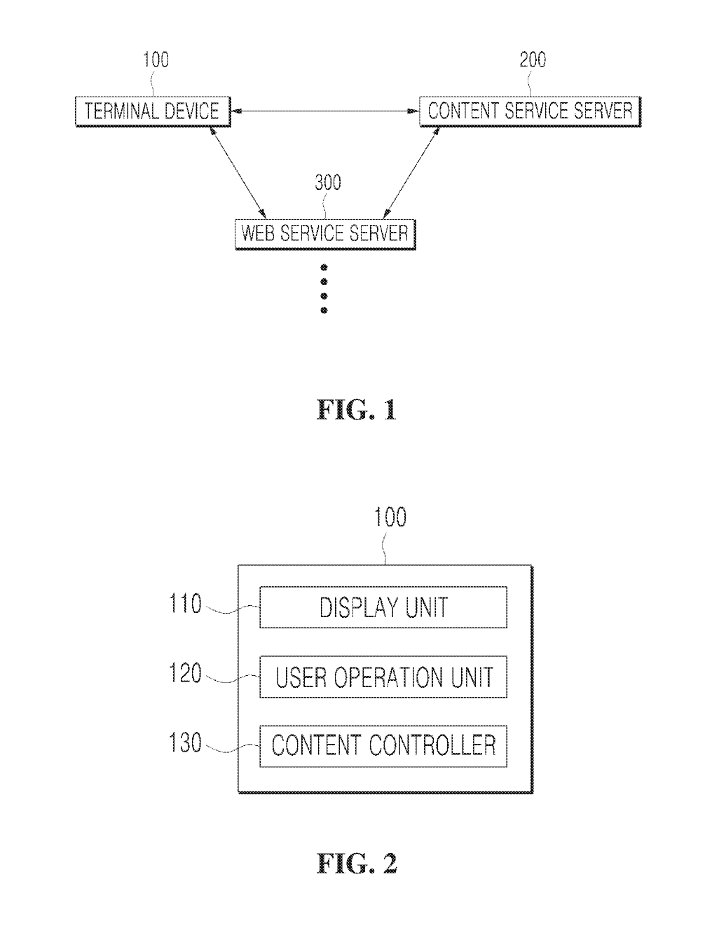

FIG. 1 is a diagram illustrating a content service system according to an exemplary embodiment of the present disclosure.

As illustrated in FIG. 1, the content service system according to the present disclosure includes a terminal device 100 for reproducing a predetermined video content, and generating tagging information corresponding to a video content based on a user comment when the user comment on a predetermined selected area designated in connection with the video content is input by a user and providing the generated tagging information to a corresponding content service server 200, and the content service server 200 for registering an article corresponding to the tagging information in one or more corresponding web service servers 300 based on the tagging information provided from the terminal device 100.

The terminal device 100 is a reproduction device capable of reproducing a video contents acquired through various schemes. The terminal device 100 may include a broadcast reproduction device for reproducing a video content, such as real-time broadcasted broadcast contents or VOD contents and a reproduction device for requesting/downloading a separated video content (e.g. a movie) through a web environment, storing the video content or copying/storing the video content through a portable storage device, and then reproducing the video content according to a reproduction selection of a user.

When the predetermined selected area related to the video content is designated and the user comment on the selected area is input by the user, the terminal device 100 generates the tagging information on the corresponding video content based on the input user comment.

In this case, when posting request information containing at least one of web service server information, log-in related information, and information on selection of publication or non-publication for a web service to which a request for posting of the user comment is made is input from the user together with the input of the user comment by the user, the terminal device 100 may generate the tagging information on the corresponding video content based on the input user comment and the posting request information.

Further, the terminal device 100 provides the generated tagging information on the video content to the content service server 200.

The content service server 200 registers an article corresponding to the tagging information in the one or more corresponding web service servers 300 based on the tagging information provided from the terminal device 100.

That is, the content service server 200 receives registration of the posting request information for each user in advance and manages the posting request information, and when the tagging information corresponding to the predetermined video content is provided from the terminal device 100, the content service server 200 may register an article corresponding to the tagging information in the one or more corresponding web service servers 300 based on the posting request information of the corresponding user of the terminal device 100.

Otherwise, when the tagging information corresponding to the predetermined video content is provided from the terminal device 100, the content service server 200 may extract/recognize the posting request information contained in the tagging information and register an article corresponding to the tagging information in the one or more corresponding web service servers 300 based on the posting request information.

Here, the web service server 300 is a server for providing a general web service (e.g., a Q&A service, a community service, and a blog service) used by many unspecified users through joining and logging-in.

The web service server 300 posts and manages the article registered by the content service server 200 and an article registered by an unspecified user, and when the unspecified user accesses the web service server 300, checks the posted article (the article registered by the content service server 200), and inputs an additional comment on the article, the web service server 300 may provide the content service server 200 with information on the input additional comment on the corresponding article (the article registered by the content service server 200) based on the additional comment on the article input by the unspecified user.

Further, the content service server 200 may generate/manage additional information on multiple target video contents to be managed.

That is, when the tagging information on the corresponding video content is provided from the terminal device 100, the content service server 200 may generate/manage the additional information on the corresponding video content based on the received tagging information. Further, when additional comment input information for the registered article is received from the web service server 300, the content service server 200 may generate/manage additional information on the corresponding video content based on the received additional comment input information.

Hereinafter, a detailed construction of the terminal device according to the present disclosure will be described with reference to FIG. 2. For convenience of the description, the terminal device 100 according to the present disclosure will be described referring to the reference numbers of FIG. 1.

As illustrated in FIG. 2, the terminal device 100 according to the present disclosure includes a user operation unit 120 for an operation by a user, and a content controller 130 for reproducing a predetermined video content, and generating tagging information on the video content based on a user comment when a predetermined selected area related to the video content is designated and the user comment on the selected area is input according to the operation by the user through the user operation unit 120 and providing the generated tagging information to the corresponding content service server 200.

The user operation unit 120 is a function unit for a user operation, and may include various types of input devices, such as a keypad, a mouse, and a touchpad, and receive an input of a user operation.

When the reproduction of a predetermined video content is selected according to the user operation through the user operation unit 120, the content controller 130 reproduces a corresponding video content selected for the reproduction. For example, when a broadcast channel is selected according to the user operation through the user operation unit 120, the content controller 130 may reproduce a video content of the selected broadcast channel. Otherwise, when the reproduction of a pre-stored video content (e.g., VOD content 1 or movie 2) is selected according to the user operation through the user operation unit 120, the content controller 130 may reproduce a corresponding video content selected for the reproduction.

A video according to the video content (e.g., a broadcasting or movie 2) reproduced by the content controller 130 may be displayed on the display unit 110.

When a predetermined selected area related to the video content is designated and a user comment on the selected area is input according to the user operation through the user operation unit 120, the content controller 130 generates tagging information on the video content based on the user comment.

More particularly, when tagging input is selected according to the user operation through the user operation unit 120, the content controller 130 recognizes a scene image selected by the user for the tagging input in connection with the currently reproduced video content (e.g., the broadcasting or movie 2).

For example, when a dynamic thumbnail image of the currently reproduced video content (e.g., the broadcasting or movie 2) is sufficiently short (e.g. one or more frames per second), the user watching the video displayed on the display unit 110 may select a scene image by selecting a dynamic thumbnail of a specific reproduction time in which the user desires to input the user comment through the user operation unit 120.

Otherwise, when a dynamic thumbnail image of the currently reproduced video content (e.g., the broadcasting or movie 2) is excessively long or there is no dynamic thumbnail corresponding to a desired scene, the user watching the video displayed on the display unit 110 may select a scene image by stopping the reproduction at a specific reproduction time at which the user desires to input the user comment, capturing a reproduced scene and pre-storing a captured image, and then selecting the stored captured image through the user operation unit 120.

Accordingly, the content controller 130 recognizes the thumbnail image corresponding to the specific reproduction time of the video content or the captured image generated by capturing the reproduced scene corresponding to the specific reproduction time of the video content according to the user operation through the user operation unit 120 as the scene image. Then, the content controller 130 provides a selected area designation User Interface (UI) for inducing the designation of a specific image area of the recognized scene image (e.g., the thumbnail image or the captured image) in which the user desires to input the user comment as the selected area. Accordingly, the user may designate a spatial selected area on the screen image for the video content through the selected area designation UI.

In this case, when the video according to the currently reproduced video content (e.g., movie 2) is being displayed on the display unit 110, it is preferable that the content controller 130 displays the scene image and provides the selected area designation UI on a partial region (e.g., a lower end of the screen) of the display unit 110.

For example, the content controller 130 may provide the selected area designation UI enabling the user to directly draw a contour line and designate the selected area in the recognized scene image or the selected area designation UI providing contour boxes having a formalized shape (e.g. a quadrangle, a circle, or the like) with different sizes and enabling the user to designate the selected area by displaying a contour box on a user desired image area in the recognized scene image.

In the meantime, when the tagging input is selected according to the user operation through the user operation unit 120, the content controller 130 may provide a selected area designation UI for inducing the designation of a specific reproduction section in connection with the video content (e.g., movie 2) as the selected area.

That is, when the user selects the tagging input through the user operation unit 120, the content controller 130 may provide the selected area designation UI enabling the user to designate the selected area by selecting a specific reproduction section (e.g., 15 min. 00 sec. to 30 min. 00 sec. of the reproduction time) in which the user desires to input the user comment from the video content (e.g., movie 2). Accordingly, the user may designate a temporal selected area for the video content through the selected area designation UI.

In this case, when the video corresponding to the currently reproduced video content (e.g., movie 2) is displayed on the display unit 110, it is preferable that the content controller 130 provides the selected area designation UI on the partial region of the display unit 110 (e.g., the lower end of the screen). The selected area designation UI may have a form of a progress bar indicating a reproduction position of the video content.

As described, when the selected area is designated according to the user operation through the user operation unit 120, the content controller 130 provides a comment input UI for inducing input of the user comment including at least one of a reply, a question, a relevant opinion, a comment, a relevant URL, and an advertisement in connection with the designated selected area.

In this case, when the video according to the currently reproduced video content (e.g., movie 2) is being displayed on the display unit 110, it is preferable that the content controller 130 provides the comment input UI on the partial region (e.g., the lower end of the screen) of the display unit 110. Especially, when the selected area is designated in the recognized scene image (e.g., the thumbnail image or the captured image), the content controller 130 may display the scene image (in a state of the selected area designation) and provide the comment input UI on the partial region (e.g., the lower end of the screen) of the display unit 110.

Accordingly, when the user comment (e.g., a question, a related opinion, a comment, a relevant URL, or an advertisement) is input according to the user operation through the user operation unit 120 in the comment input UI, the content controller 130 generates the tagging information on the video content (e.g., movie 2) based on the input user comment.

Otherwise, when the user comment is input according to the user operation through the user operation unit 120 in the comment input UI, the content controller 130 may provide a posting selection UI for inducing selection of posting of the user comment input through the comment input UI to a web service.

In this case, when the video according to the currently reproduced video content (e.g. the broadcast or movie 2) is being displayed on the display unit 110, it is preferable that the content controller 130 provides the posting selection UI on the partial region (e.g., the lower end of the screen) of the display unit 110. Especially, when the selected area is designated in the recognized scene image (e.g., the thumbnail image or the capture image), the content controller 130 may display the scene image (in a state of the selected area designation) and provide the posting selection UI on the partial region (e.g. the lower end of the screen) of the display unit 110.

Accordingly, when a web service posting request is selected through the posting selection UI and posting request information containing at least one of web service server information, log-in related information, and information on selection of publication or non-publication for at least one web service to which a request for posting of the user comment is made is input according to the user operation through the user operation unit 120, the content controller 130 may generate tagging information on the video content (e.g., the broadcast or movie 2) based on the input user comment and the input posting request information.

Here, the posting selection UI may include a web service server information selection item corresponding to a representative web service (e.g., a Q&A service, a community service, and a blog service) so as to enable the user to select a web service in which the user desires to register/post the user comment input by the user himself/herself or a web service server information input window so as to enable the user to directly input a server access address for the web service, a log-in related information input window so as to enable the user to input a log-in ID/password registered in a corresponding web service server, and a selection window for selecting information on the selection of the publication or non-publication so as to enable the user to select whether to publish an article corresponding to the user comment input by the user himself/herself (e.g., publication/non-publication to many unspecified users, publication/non-publication to acquaintances, publication to only the user himself/herself, etc.) and whether to publish an additional comment input in connection with the corresponding article (e.g., publication/non-publication to many unspecified users, publication/non-publication to acquaintances, publication to only the user himself/herself, etc.).

Accordingly, the content controller 130 may generate the tagging information on the video content (e.g. the broadcast or movie 2) based on the posting request information containing at least one of the web service server information, the log-in related information, and the information on the selection of the publication or non-publication selected or input through the posting selection UI and the input user comment (e.g., question 1).

Accordingly, the tagging information generated by the content controller 130 may contain at least one of the input user comment (e.g., question 1), information on a corresponding video content (e.g. video content identification information, URL information on the video content) in which the user comment is input, scene image information (e.g., reproduction time information, an scene image) including a reproduction time of the scene image in which the user comment is input, selected area information (e.g., information on a position within the scene image) indicating the selected area designated in the scene image, selected area information (e.g., time information on the reproduction section, 15 min. 00 sec. to 30 min. 00 sec. and the video of the reproduction section) indicating the selected area corresponding to a reproduction section (e.g., 15 min. 00 sec. to 30 min. 00 sec. of the reproduction time) in which the user comment is input, and the posting request information (for example, including at least one of the web service server information, the log-in related information, and the information on the selection of the publication or non-publication).

Accordingly, the content controller 130 provides the corresponding content service server 200 with the generated tagging information. It is a matter of course that the content controller 130 inserts terminal identification information based on which the terminal device 100 to which the content controller 130 belongs may be identified and/or user identification information (e.g. an ID/password for the content service server 200, a user identification number, etc.,) based on which a user currently using the terminal device 100 may be identified in the tagging information to generate the tagging information, or may provide the content service server 200 with the tagging information together with the terminal identification information and/or the user identification information.

In this case, the content controller 130 may be in a state in which access information for accessing the content service server 200 has been already registered therein in order to provide the generated tagging information, or recognize accessing information for accessing the server (e.g., the content service server 200) in order to provide the tagging information based on the additional information on the video content (e.g., the broadcast or movie 2) corresponding to the generated tagging information.

In the meantime, the content controller 130 may simultaneously display the progress bar indicating a reproduction position of the video in reproducing the video content (e.g., the broadcast or movie 2) and displaying the corresponding video in the display unit 110.

In this case, the progress bar is preferably configured in a manner such that existence of the tagging information at a corresponding position of the progress bar including the pre-registered tagging information may be identified based on the possessed additional information on the video content (e.g., the broadcast or movie 2).

That is, the content controller 130 may extract the tagging information on the video content (e.g., the broadcast or movie 2) pre-registered in connection with the reproduced video content (e.g., the broadcast or movie 2) based on the possessed additional information received from the content service server 200, and display a marking (e.g., an indication with a different color from that of a peripheral area or an indication of an identification mark (e.g., an arrow)) indicating the existence of the tagging information at the corresponding position of the progress bar based on the scene image information (e.g., the reproduction time information) contained in the extracted tagging information or the selected area information (e.g., 15 min. 00 sec. to 30 min. 00 sec. of the reproduction section time information) contained in the extracted tagging information.

Further, when tagging information view for a specific position of the progress bar is selected according to the user operation through the user operation unit 120, the content controller 130 may display the user comment based on at least one of tagging information corresponding to the reproduction time of the selected specific position of the progress bar based on the additional information on the video content (e.g., the broadcast or movie 2).

That is, when the user, who recognizes the existence of the tagging information at the specific position through the displayed progress bar, selects the tagging information view for the specific position through the user operation unit 120, the content controller 130 extracts at least one of tagging information corresponding to the specific position for which the tagging information view is selected and displays the user comment (e.g., advertisement 1, question 2, and relevant URL 3) included in each of the extracted tagging information on the display unit 110 based on the additional information on the video content (e.g., the broadcast or movie 2). Accordingly, the user may identify the displayed user comment. In this case, when the scene image is contained in the extracted tagging information, the content controller 130 may display the corresponding scene image (in a state of the selected area designation) together with the user comment (e.g., advertisement 1, question 2, and relevant URL 3).

In this case, when the video according to the currently reproduced video content (e.g., the broadcast or movie 2) is being displayed on the display unit 110, it is preferable that the content controller 130 displays at least one user comment according to the tagging information view on the partial region (e.g., the lower end of the screen) of the display unit 110.

Accordingly, when the user selects the displayed specific user comment (e.g., relevant URL 3) through the user operation unit 120, the content controller 130 may make a web communication controller (not shown) access the corresponding relevant URL 3 by transferring relevant URL 3 to another function unit (e.g., the web communication controller (not shown)) within the terminal device 100.

Further, when the user selects the displayed specific user comment (e.g., question 2) through the user operation unit 120, the content controller 130 may display detailed contents (e.g., entire contents of the question and at least one reply to the question) of the selected user comment (e.g., question 2) based on the corresponding tagging information.

Accordingly, in reproducing the video content and displaying the video, the terminal device 100 according to the present disclosure enables the user of the terminal device 100 to easily recognize a reproduction position of the video including a user comment pre-registered by another user through the progress bar, thereby making the user easily and rapidly discover the corresponding user comment.

In the meantime, when an additional comment is written on the articles of the user of the terminal device 100 in each web service server 300, the terminal device 100 may show a name of a web service name (e.g., Q&A of Naver or Community of Google) including the additional comment and a summary of the additional comment (e.g., titles of additional comments 1 and 2) such that the user of the terminal device 100 may recognize the additional comment.

To this end, when predetermined article history/article relevant information is provided from the content service server 200, the content controller 130 may display additional comment summary information based on the received article history/article relevant information in a predetermined region of the display unit 110. For example, the content controller 130 may display the additional comment summary information in a form of a pop-up in a predetermined region of the display unit 110 based on the article history/article relevant information.

Here, the article history/article relevant information is information separately provided from the content service server 200, which is different from the additional information provided in connection with the video content reproduced in the terminal device 100.

The article history/article relevant information contains at least one of the user identification information (e.g., an ID/password for the content service server 200, a user identification number, and the like), at least one tagging information, article information indicating the article registered in connection with each tagging information (e.g., registered web service server information, article identification information, and the like), additional comment input information corresponding to each article information (e.g., additional comment information, for example, a title of the additional comment and contents of the additional comment), and additional comment writer information (e.g., an ID of a writer and additional comment written time information).

When the article history/article relevant information is provided from the content service server 200, the additional comment summary information may be displayed in a predetermined region of the display unit 110 based on the information contained in the article history/article relevant information.

Here, the additional comment summary information may contain the number of pieces of additional comment input information (e.g., three questions 1 and one question 3) on each of the user comments (e.g., question 1 and question 3) contained in each of at least one tagging information, and brief information (e.g., titles of additional comments 1, 2, 3, and 4, and corresponding web service server information on the additional comment) on each additional comment input information. Accordingly, the user may recognize a name of a web service (e.g., Q&A of Naver and Community of Google) in which the additional comment is written on the comments of the user and a summary of the additional comment (e.g., a title of the additional comment) through the additional comment summary information displayed in the terminal device 100. Accordingly, when specific brief information (e.g., a title of additional comment 1) is selected from the additional comment summary information according to the user operation through the user operation unit 120, the content controller 130 may display detailed contents corresponding to the selected brief information (e.g., a title of additional comment 1) in a predetermined region of the display unit 110.

That is, the content controller 130 may display detailed contents containing the user comment (e.g., question 1) contained in the corresponding tagging information within the article history/article relevant information corresponding to the selected brief information (e.g., the title of additional comment 1), the corresponding scene image (in a state of the selected area designation), the additional comment information contained in the additional comment input information within the article history/article relevant information (e.g., the title of additional comment 1, contents of additional comment 1), writer information on additional comment 1 (e.g., an ID of the writer), and information on a written time of additional comment 1.

Otherwise, the content controller 130 may transfer the article information (e.g., the information on the web service in which the article is registered and the article identification information) within the article history/article relevant information corresponding to the selected brief information (e.g., the title of additional comment 1) to another function unit (e.g., the web communication controller (not shown)) within the terminal device 100, and make the web communication controller (not shown) access the corresponding web service server 300 to access the corresponding article.

Accordingly, when the user of the terminal device 100 reproducing/watching the video content inputs the user comment (e.g., a question) on an image area or a specific reproduction section of a specific scene, the terminal device 100 according to the present disclosure generates the tagging information according to the input user comment, provides the generated tagging information to the corresponding content service server 200, thereby enabling the content service server 200 to automatically register a corresponding article in the web service based on the tagging information, and displays the additional comment summary information and/or the detailed contents based on the article history/article relevant information of the user of the terminal device 100 according to the input of additional comments (e.g., replies) by many unspecified users reading the article by using the web service, thereby enabling the user to rapidly and conveniently check the additional comments (e.g., the replies) on the user comment, i.e., the article, input by the user of the terminal device 100.

Here, the content controller 130 may have a form of a media player for reproducing a video content and providing the aforementioned tagging input function, tagging information view function, and additional comment summary information/detailed contents.

As described above, the terminal device 100 according to the present disclosure provides an environment allowing the user of the terminal device 100 reproducing/watching the video content to easily and freely input the user comment on the image area or the specific reproduction section of the specific scene, and generates the tagging information on the input user comment and provides the generated tagging information to the corresponding content service server 200, to make the content service server 200 automatically register/post the corresponding article to the web service based on the tagging information, thereby enabling the user to acquire desired additional comments, such as responses and opinions, from a group of many unspecified intelligent users who use the web service.

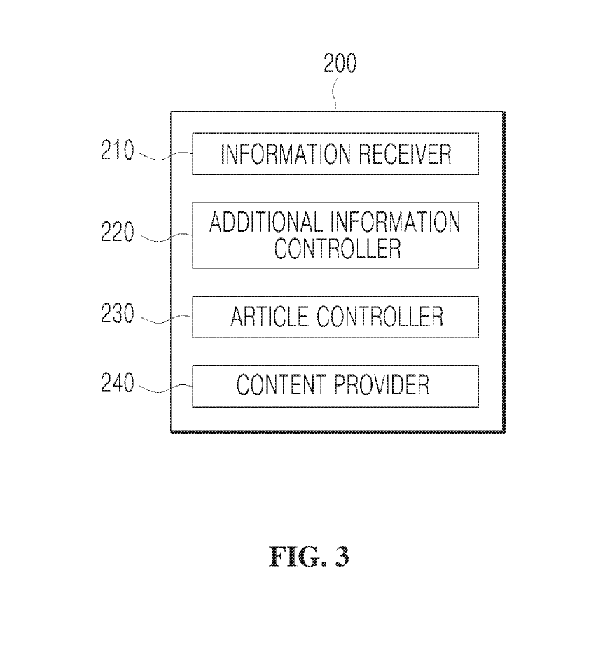

Hereinafter, the construction of the content service server according to the present disclosure will be described in detail with reference to FIG. 3. For the convenience of description, the detailed description will be given with reference to reference numbers of the content service server 200 according to the present disclosure of FIG. 1.

As illustrated in FIG. 3, the content service server 200 according to the present disclosure includes an information receiver 210 for receiving predetermined tagging information provided from the external terminal device 100 and an article controller 230 for registering an article corresponding to the tagging information in at least one corresponding web service server 300 based on the tagging information received through the information receiver 210.

The tagging information provided from the terminal device 100 through the information receiver 210 contains at least one of a user comment, information on a corresponding video content in which the user comment is input, scene image information including a reproduction time of a scene image in which the user comment is input, selected area information indicating a selected area designated in the scene image, selected area information indicating a selected area corresponding to a reproduction section in which the user comment is input, and posting request information containing at least one of information on a predetermined web service server, log-in related information, and information on selection of publication or non-publication.

A method of registering the article corresponding to the tagging information by the article controller 230 will be described in detail.

The article controller 230 may receive registration of the posting request information containing at least one of the predetermined web service server information, the log-in related information, and the information on the selection of the publication or non-publication for which a request for posting of the user comment is made for each user in advance, and store and manage the posting request information.

That is, the posting request information is registered and managed in the article controller 230 for each user, and each posting request information may contain the web service server information (e.g., a server access address) on the web service (e.g., a Q&A service, a community service, and a blog service) designated/requested to register/post the user comment included in the tagging information, the log-in relevant information including a log-in ID/password of the user registered in the corresponding web service server, and the information on the selection of the publication or non-publication designating/requesting the publication or the non-publication (e.g., publication/non-publication to many unspecified users, publication/non-publication to acquaintances, publication only to the user himself/herself, etc.) of the article corresponding to the input user comment and the publication or the non-publication (e.g., publication/non-publication to many unspecified users, publication/non-publication to acquaintances, publication only to the user himself/herself, etc.) of the additional comment input in connection with the corresponding article.

Accordingly, when the tagging information is received from the predetermined terminal device 100 through the information receiver 210, the article controller 230 may register the article corresponding to the tagging information in at least one corresponding web service server 300 based on the posting request information of the user corresponding to the received tagging information.

That is, the article controller 230 accesses the corresponding web service server 300 based on the posting request information, performs a log-in process based on the ID/password of the corresponding user by using the log-in relevant information, generates and registers the article including at least one of the predetermined user comment (e.g., question 1) contained in the tagging information, the information on the corresponding video content (e.g. video content identification information and URL information on the video content) in which the user comment is input, the scene image information (e.g., the reproduction time information and the scene image) including the reproduction time of the scene image in which the user comment (e.g., question 1) is input, and the selected area information indicating the selected area designated in the scene image (e.g., the information on a position within the scene image), and sets an item for the publication or non-publication of the registered article and/or the additional comment registered in connection with the registered article according to the information on the selection of the publication or non-publication, to register the article.

Otherwise, the article controller 230 may not receive the registration of the posting request information for each user and manage the posting request information. In this case, when the tagging information is received from the terminal device 100 through the information receiver 210, the article controller 230 extracts/recognizes the posting request information from the received tagging information.

The extracted/recognized posting request information may contain the web service server information (e.g., a server access address) on the web service (e.g., a Q&A service, a community service, and a blog service) designated/requested to register/post the user comment included in the tagging information, the log-in relevant information including the log-in ID/password of the user registered in the corresponding web service server, and the information on the selection of the publication or non-publication designating/requesting the publication or the non-publication (e.g., publication/non-publication to many unspecified users, publication/non-publication to acquaintances, publication only to the user himself/herself, etc.) of the article corresponding to the input user comment and the publication or the non-publication (e.g., publication/non-publication to many unspecified users, publication/non-publication to acquaintances, publication only to the user himself/herself, etc.) of the additional comment input in connection with the corresponding article.

Accordingly, the article controller 230 may register the article corresponding to the received tagging information in the corresponding web service server 300 based on the posting request information extracted/recognized from the tagging information received through the information receiver 210.

That is, the article controller 230 accesses the corresponding web service server 300 based on the posting request information, performs a log-in process based on the ID/password of the corresponding user by using the log-in relevant information, generates and registers the article including at least one of the predetermined user comment (e.g., question 1) contained in the tagging information, the information on the corresponding video content (e.g. video content identification information and URL information on the video content) in which the user comment is input, the scene image information (e.g., reproduction time information and the scene image) including the reproduction time of the scene image in which the user comment (e.g., question 1) is input, the selected area information indicating the selected area designated in the scene image (e.g., the information on a position within the scene image), and the selected area information (e.g., time information on the reproduction section: 15 min. 00 sec. to 30 min. 00 sec. and a video of the reproduction section) indicating the selected area corresponding to the reproduction section (e.g., 15 min. 00 sec. to 30 min. 00 sec. of the reproduction time) in which the user comment is input, and sets an item for the publication or the non-publication of the registered article and/or the additional comment registered in connection with the registered article according to the information on the selection of the publication or non-publication, to register the article.

Accordingly, the article registered by the ID of the user logging-in the web service server 300 by the content service server 200 according to the present disclosure may include the user comment (e.g., question 1) and at least one of the scene image (in a state of the selected area designation) or the video in connection with the corresponding reproduction section in which the user comment (e.g., question 1) is input, and include URL information on the video content so as to partially or entirely reproduce the corresponding video content when the corresponding video content is a free content or when an excerpt of the corresponding video content is permitted from a content owner in advance (a form of a plug-in player).

It is a matter of course that when the content service server, specifically the article controller 230, registers the article according to the tagging information in the web service server 300, the article controller 230 may simultaneously provide various interactive services, such as a link to a relevant advertisement or a commerce site.

Accordingly, many unspecified users capable of reading the article by accessing the web service server 300 may read the article corresponding to the user comment (e.g., question 1) on the specific selected area input during a time when the user of the terminal device 100 watches the video through his/her terminal device 100 or check the article by reproducing a part/an entirety of the video content related to the article, to input their additional comments (e.g., replies) on the article.

Then, it is preferable that the article controller 230 generates/manages the article history/article relevant information on the article registered in connection with the tagging information for each user. That is, the article controller 230 manages the article history/article relevant information for each user, and the article history/article relevant information contains at least one of the user identification information (e.g., an ID/password for the content service server 200, a user identification number, and the like), at least one of tagging information provided in connection with the corresponding user, article information indicating the article registered in connection with each tagging information (e.g., registered web service server information, article identification information, and the like), additional comment input information corresponding to each article information (e.g., additional comment information, for example, a title of the additional comment and contents of the additional comment), and additional comment writer information (e.g., an ID of a writer and additional comment written time information).

Accordingly, when the article controller 230 registers the article to the web service server 300 based on the received tagging information, the article controller 230 updates the article history/article relevant information in connection with the corresponding user.

Then, when the article controller 230 receives predetermined additional comment input information from the web service server 300 in connection with the article registered at least one web service server 300, the article controller 230 updates the corresponding article history/article relevant information in connection with the corresponding user based on the additional comment input information.

Here, the additional comment input information provided from the web service server 300 may contain the article information containing the article identification information on the corresponding article on which the additional comment is input and the web service server information indicating the web service server 300 itself, information on a writer who inputs the additional comment (e.g., an ID of a writer), the additional comment written time information, and the additional comment information (e.g., a title of the additional comment and contents of the additional comment).

Accordingly, the article controller 230 may update the article history/article relevant information in connection with the corresponding user having the corresponding article identification information based on the additional comment input information provided from the web service server 300.

Then, when the terminal device 100 of the corresponding user is in an access state while the article controller 230 updates the article history/article relevant information in connection with the corresponding user according to the additional comment input information received from the web service server 30, the article controller 230 may provide the article history/article relevant information in connection with the corresponding user to the terminal device 100 to make the terminal device 100 display the additional comment summary information according to the article history/article relevant information.

Otherwise, when the terminal device 100 of a predetermined user is connected, the article controller 230 may provide the article history/article relevant information in connection with the predetermined user to the terminal device 100 to make the terminal device 100 display the additional comment summary information according to the article history/article relevant information.

Accordingly, as described above, the terminal device 100 displays the additional comment summary information in a predetermined region based on the information contained in the article history/article relevant information, thereby enabling the user of the terminal device 100 to recognize a name of the web service (e.g., Q&A of Naver and Community of Google) in which the additional comment is written on the article of the user of the terminal device 100 and a summary of the additional comment (e.g., titles of additional comments 1 and 2) through the additional comment summary information.

In the meantime, the content service server 200 according to the present disclosure may further include an additional information controller 220.

The additional information controller 220 generates/manages additional information on the corresponding video content based on at least one of the provided tagging information and the additional comment input information received from the web service server 300 in connection with the article registered in at least one web service server 300.

That is, the additional information controller 220 generates/manages the additional information on the corresponding video content based on the tagging information, i.e., the tagging information containing at least one of the user comment, the information on the corresponding video content in which the user comment is input, the scene image information including the reproduction time of the scene image in which the user comment is input, the selected area information indicating the selected area designated in the scene image, the selected area information indicating the selected area corresponding to the reproduction section in which the user comment is input, and the posting request information containing at least one of the information on the predetermined web service server, the log-in related information, and the information on the selection of the publication or non-publication, received from the information receiver 210.

Further, the additional information controller 220 generates/manages the additional information on the corresponding video content based on the additional comment input information on the predetermined article, i.e., the additional comment input information containing at least one of the article information (e.g., the article identification information and the web service server information), the information on the writer who inputs the additional comment (e.g., the ID of the writer), the additional comment written time information, and the additional comment information (e.g., the title of the additional comment and the contents of the additional comment), received from the web service server 300. The additional information controller 220 may recognize the video content corresponding to the article identification information contained in the additional comment input information based on the article history/article relevant information, and thus the additional information controller 220 may generate/manage the additional information on the corresponding video content based on the additional comment input information.

The additional information on each video content managed by the additional information controller 220 is generated based on at least one tagging information pre-provided from multiple users who reproduce/watch the corresponding video content (e.g., movie 2), i.e. the tagging information on various selected areas (e.g., image areas of specific scenes or specific reproduction sections) pre-provided from multiple users for the corresponding video content (e.g., movie 2), and the additional comment input information corresponding to additional comments (e.g., replies) of many unspecified users reading the article corresponding to the tagging information. The additional information may be meta information on the video content.

As illustrated in FIG. 3, the content service server 200 according to the present disclosure may further include a content provider 230.

When the terminal device 100 requests a predetermined video content, the content provider 230 provides the terminal device 100 with the additional information generated/managed in connection with the requested video content.

For example, in a case where the content service server 200 performs only an additional information management function, when the terminal device 100 makes a request for the video content (e.g., movie 2) to a separate content providing server (not shown), the content service server 200 interworks with the content providing server (not shown), so that the content provider 230 may recognize the request for the video content (e.g., movie 2) by the terminal device 100 and provide the terminal device 100 with the additional information generated/managed in connection with the requested video content (e.g., movie 2).

Otherwise, in a case where the content service server 200 performs a video content providing function, as well as the additional information management function, when the terminal device 100 makes a request for the video content (e.g., movie 2) to the content service server 200, the content provider 230 may provide the terminal device 100 with the pre-possessed video content (e.g., movie 2) together with the additional information generated/managed in connection with the video content (e.g., movie 2).

Accordingly, the content service server 200 according to the present disclosure may effectively generate/manage additional information on each video content based on the tagging information according to the user comment on the selected area (e.g., an image area or a specific reproduction section of a specific scene) provided for each video content from the multiple terminal devices 100.

Accordingly, the content service server 200 according to the present disclosure automatically registers/posts the corresponding article in the web service based on the tagging information according to the user comment on the image section or the specific reproduction section of the specific scene provided from the terminal device 100 and provides the terminal device 100 of the corresponding user with the article history/article relevant information based on the additional comment input information corresponding to the article registered in the web service, thereby enabling the user to acquire desired additional comments, such as responses/opinions, about the user comment from a group of many unspecified intelligent users who use the web service.

As described above, the content service system including the terminal device 100 and the content service server 200 according to the present disclosure provides an environment allowing the user of the terminal device 100 reproducing/watching the video content to easily and freely input the user comment on the specific selected area (e.g., the image area or the specific reproduction section of the specific scene), and generates the tagging information on the input user comment and provides the corresponding content service server 200 with the generated tagging information, to make the content service server 200 automatically register the article to the web service based on the tagging information, thereby enabling the user to acquire/check additional comments, such as responses and opinions, on the user comment of the user of the terminal device 100 from the group of many unspecified intelligent users who use the web service through the terminal device 100 and effectively generating/managing the additional information on each video content based on the tagging information and the additional comment input information according to the additional comments from the terminal devices 100 of the many unspecified users.

Accordingly, the content service system according to the present disclosure enables the user of the terminal device 100 to acquire/check additional comments, such as responses and opinions, on the user comment on the specific selected area (e.g., the image area or the specific reproduction section of the specific scene) of the video input by the user of the terminal device 100 from the group of many unspecified intelligent users who use the web service through the terminal device 100, thereby being capable of supporting the acquisition of detailed and broad information for the user, and effectively generates/manages the additional information on respective video contents based on the user comments provided in connection with the respective video contents from the terminal devices 100 of many unspecified users and the additional comments of a group of many unspecified intelligent users on the article, thereby being capable of effectively generating/managing more detailed and various additional information on the video by the many unspecified users and providing the detailed and various additional information to another user.

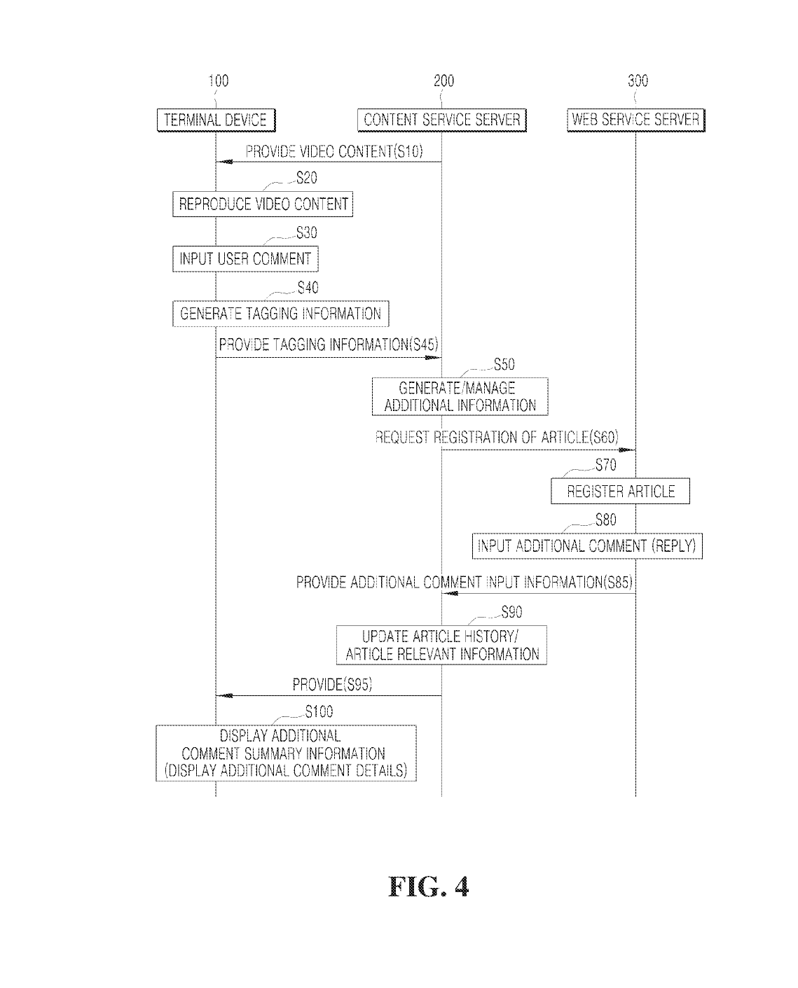

Hereinafter, a content service method according to an exemplary embodiment of the present disclosure will be described with reference to FIGS. 4 to 6. For the convenience of description, the detailed description of the construction illustrated in FIGS. 1 to 3 will be given with reference to corresponding reference numbers.

First, a content service method according to an exemplary embodiment of the present disclosure will be described with reference to FIG. 4.

The terminal device 100 reproduces a video content acquired through various schemes (S20).

The terminal device 100 may include a broadcast reproduction device for reproducing a video content, such as real-time broadcasted broadcast contents or VOD contents and a reproduction device for requesting/downloading a separated video content (e.g. a movie) through a web environment, storing the video content or copying/storing the video content through a portable storage device, and then reproducing the video content according to a reproduction selection of a user. Accordingly, the terminal device 100 may receive the requested video content from the content service server 200 (S10) to reproduce the video content.

When a predetermined selected area related to the currently reproduced video content is designated and a user comment in connection with the selected area is input by the user (S30), the terminal device 100 generates tagging information on the corresponding video content based on the input user comment (S40).

Then, the terminal device 100 provides the corresponding content service server 200 with the generated tagging information on the video content (S45).

When the tagging information corresponding to the predetermined video content is received from the terminal device 100, the content service server 200 may generate/manage additional information on the corresponding video content based on the provided tagging information (S50). As such, the content service server 200 may generate/manage the additional information on various target video contents to be managed by the content service server 200.

Further, the content service server 200 may register an article corresponding to the tagging information in at least one corresponding web service server 300 based on the received tagging information. That is, the content service server 200 may make a request for registration of the article corresponding to the tagging information to at least one corresponding web service server 300 based on the received tagging information (S60), and the web service server 300 may register the article requested for registration by the content service server 200 (S110) and post/manage the article.

When an unspecified user accesses the web service server 300, checks the posted article (the article registered by the content service server 200), and inputs an additional comment on the article (S80), the web service server 300 may provide the content service server 200 with additional comment input information on the corresponding article (the article registered by the content service server 200) based on the additional comment on the article input by the unspecified user (S85).

Accordingly, the content service server 200 may update the article history/article relevant information managed for each user based on the received additional comment input information (S90), and provide the connected terminal device 100 of the corresponding user with the article history/article relevant information of the corresponding user depending on the necessity (S95).

Accordingly, the terminal device 100 may display the additional comment summary information on a predetermined region based on the information contained in the article history/article relevant information provided from the content service server 200, and display detailed contents corresponding to specific brief information selected from the additional comment summary information according to an operation of the user (S100).

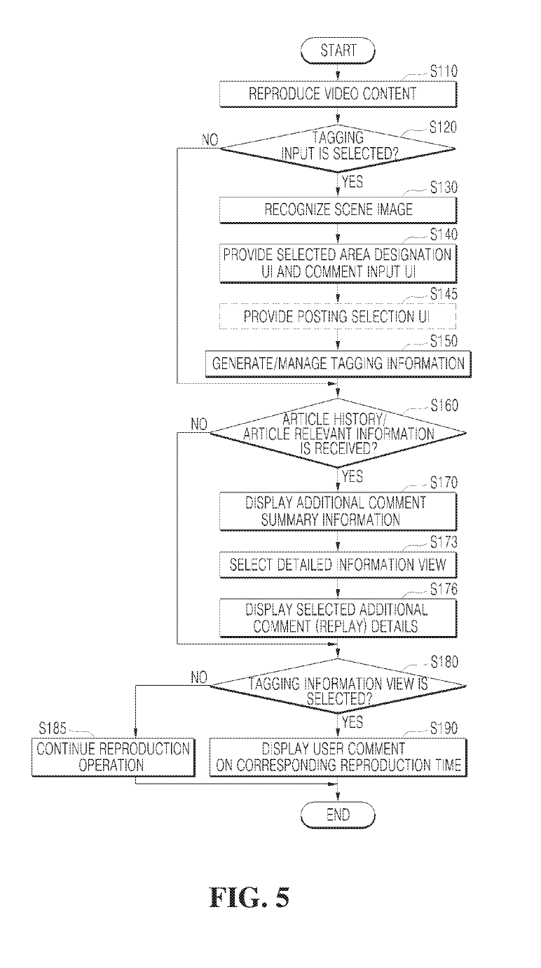

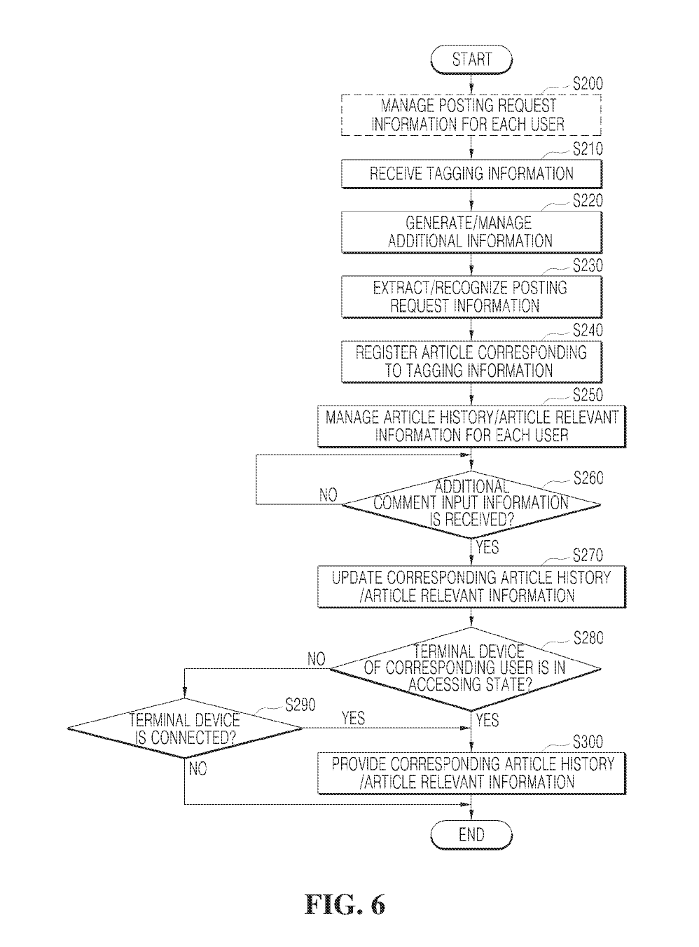

Hereinafter, a method of using a content service by the terminal device 100 according to the present disclosure will be described with reference to FIG. 5.

In the method of using the content service by the terminal device 100 according to the present disclosure, when reproduction of a predetermined video content is selected according to the operation by a user, the selected video content for the reproduction is reproduced (S110). For example, in the method of using the content service by the terminal device 100 according to the present disclosure, when a broadcast channel is selected according to the user operation, a video content, i.e., the broadcast content, of the selected broadcast channel may be reproduced, or when the reproduction of a pre-stored video content (e.g., VOD content 1 or movie 2) is selected according to the user operation, the corresponding video content selected for the reproduction may be reproduced.

A video according to the reproduced video content may be displayed on the display unit 110.

In this case, in the method of using the content service by the terminal device 100 according to the present disclosure, when the corresponding video is displayed on the display unit 110 according to the reproduction of the video content (e.g., movie 2), the progress bar indicating a reproduction position of the video may be simultaneously displayed.

In this case, in the method of using the content service by the terminal device 100 according to the present disclosure, the progress bar is preferably configured in a manner such that existence of the tagging information at a corresponding position of the progress bar including the pre-registered tagging information may be identified based on the possessed additional information on the video content (e.g., the broadcast or movie 2).

That is, in the method of using the content service by the terminal device 100 according to the present disclosure, the tagging information on the video content (e.g., movie 2) pre-registered in connection with the reproduced video content (e.g., movie 2) is extracted based on the possessed additional information received from the content service server 200 in connection with the reproduced video content (e.g., movie 2), and a marking (e.g., an indication with a different color from that of a peripheral area, and a display of an identification mark (e.g., an arrow)) indicating the existence of the tagging information at the corresponding position of the progress bar based on scene image information (e.g., reproduction time information) contained in the extracted tagging information or selected area information (e.g., 15 min. 00 sec. to 30 min. 00 sec. of reproduction section time information) contained in the extracted tagging information may be displayed.

Further, in the method of using the content service by the terminal device 100 according to the present disclosure, when a selected area related to the video content is designated according to the user operation and a user comment on the selected area is input, the tagging information on the video content is generated based on the user comment.

More specifically, in the method of using the content service by the terminal device 100 according to the present disclosure, whether tagging input is selected according to the user operation is determined (S120), and when the tagging input is selected, a scene image selected by the user for the tagging input in connection with the reproduced video content (e.g., movie 2) is recognized (S130).

For example, when a dynamic thumbnail of the currently reproduced video content (e.g., movie 2) is sufficiently short (e.g. one or more frames per second), the user watching the video displayed on the display unit 110 may select a scene image by selecting a dynamic thumbnail of a specific reproduction time in which the user desires to input the user comment.

Otherwise, when an interval between dynamic thumbnails of the currently reproduced video content (e.g., movie 2) is excessively long or there is no dynamic thumbnail corresponding to a desired scene, the user watching the video displayed on the display unit 110 may select a scene image by stopping the reproduction at a specific reproduction time at which the user desires to input the user comment, capturing a reproduced scene and pre-storing a captured image, and then selecting the stored captured image.

Accordingly, in the method of using the content service by the terminal device 100 according to the present disclosure, the thumbnail image corresponding to the specific reproduction time of the video content or the captured image generated by capturing the reproduced scene corresponding to the specific reproduction time of the video content according to the user operation is recognized as the scene image.

Further, in the method of using the content service by the terminal device 100 according to the present disclosure, a selected area designation UI for inducing the designation of a specific image area in the recognized scene image (e.g., the thumbnail image or the captured image) in which the user desires to input the user comment as the selected area is provided, and in the method of using the content service by the terminal device 100 according to the present disclosure, when the selected area for the scene image (e.g., the thumbnail image or the captured image) is designated according to the user operation in the selected area designation UI, a comment input UI for inducing input of the user comment including at least one of a reply, a question, a relevant opinion, a comment, a relevant URL, and an advertisement in connection with the designated selected area is provided (S140).

In the meantime, in the method of using the content service by the terminal device 100 according to the present disclosure, when the tagging input is selected according to the user operation, step S130 may be excluded and a selected area designation UI for inducing the designation of the specific reproduction section as the selected area in connection with the video content (e.g., movie 2) may be provided.

That is, in the method of using the content service by the terminal device 100 according to the present disclosure, when the user selects the tagging input, the selected area designation UI enabling the user to designate the selected area by selecting a specific reproduction section (e.g., 15 min. 00 sec. to 30 min. 00 sec. of the reproduction time) in which the user desires to input the user comment from the video content (e.g., movie 2) may be provided, and when the selected area is designated according to the selection of the reproduction section, the comment input UI for inducing input of the user comment including at least one of a reply, a question, a relevant opinion, a comment, a relevant URL, and an advertisement in connection with the designated selected area may be provided (S140).

Accordingly, in the method of using the content service by the terminal device 100 according to the present disclosure, when the user comment is input according to the user operation in the comment input UI, the tagging information on the corresponding video content (e.g., movie 2) is generated based on the input user comment (e.g., question 1) and the generated tagging information is provided to the corresponding content service server 200 (S150).

Otherwise, in the method of using the content service by the terminal device 100 according to the present disclosure, when the user comment is input according to the user operation in the comment input UI, a posting selection UI for inducing selection of posting of the user comment input through the comment input UI to a web service may be provided (S145).

Accordingly, in the method of using the content service by the terminal device 100 according to the present disclosure, when a web service posting request is selected through the posting selection UI and posting request information containing at least one of web service server information, log-in related information, and information on selection of publication or non-publication for at least one web service to which a request for posting of the user comment is made is input according to the user operation, the tagging information on the corresponding video content (e.g., movie 2) may be generated based on the user comment (e.g., question 1) and the input posting request information and the generated tagging information may be provided to the corresponding content service server 200 in step S150.

Here, the posting selection UI may include a web service server information selection item corresponding to a representative web service (e.g., a Q&A service, a community service, and a blog service) so as to enable the user to select a web service in which the user desires to register/post the user comment input by the user himself/herself or a web service server information input window so as to enable the user to directly input a server access address for the web service, a log-in related information input window so as to enable the user to input a log-in ID/password registered in a corresponding web service server, and a selection window for selecting the information on the selection of the publication or non-publication so as to enable the user to select whether to publish the article corresponding to the user comment input by the user himself/herself (e.g., publication/non-publication to many unspecified users, publication/non-publication to acquaintances, publication only to the user himself/herself, etc.) and whether to publish an additional comment input in connection with the corresponding article (e.g., publication/non-publication to many unspecified users, publication/non-publication to acquaintances, publication only to the user himself/herself, etc.).

Accordingly, in the method of using the content service by the terminal device 100 according to the present disclosure, the tagging information containing at least one of the user comment (e.g., question 1), the information on a corresponding video content in which the user comment is input, the information on the corresponding video content (e.g. video content identification information, URL information on the video content) in which the user comment is input, the scene image information (e.g., the reproduction time information and the scene image) including the reproduction time of the scene image in which the user comment is input, the selected area information (e.g., information on a position within the scene image) indicating the selected area designated in the scene image, the selected area information (e.g., time information on the reproduction section: 15 min. 00 sec. to 30 min. 00 sec. and the video of the reproduction section) indicating the selected area corresponding to the reproduction section (e.g., 15 min. 00 sec. to 30 min. 00 sec. of the reproduction time) in which the user comment is input, and the posting request information (for example, including at least one of the web service server information, the log-in related information, and the information on the selection of the publication or non-publication) may be generated.

Here, in the method of using the content service by the terminal device 100 according to the present disclosure, when the generated tagging information is provided to the corresponding content service server 200, the tagging information may be generated by inserting terminal identification information based on which the terminal device 100 may be identified and/or user identification information (e.g. an ID/password for the content service server 200, a user identification number, etc.,) based on which a user currently using the terminal device 100 may be identified in the tagging information, or the terminal identification information and/or the user identification information may be provided to the content service server 200 when the tagging information is provided.

In this case, in the method of using the content service by the terminal device 100 according to the present disclosure, access information for accessing the content service server 200 may be in a state of having been already registered in order to provide the generated tagging information, or accessing information for accessing the server (e.g., the content service server 200) in order to provide the tagging information may be recognized based on the additional information on the video content (e.g., movie 2) corresponding to the generated tagging information.

In the meantime, in the method of using the content service by the terminal device 100 according to the present disclosure, when it is determined that the tagging input is not selected in step S120, it is determined whether predetermined article history/article relevant information is provided from the content service server 200 (S160), and when the predetermined article history/article relevant information is provided, additional comment summary information may be displayed in a predetermined region based on the article history/article relevant information (S170). For example, in the method of using the content service by the terminal device 100 according to the present disclosure, the additional comment summary information may be displayed in a predetermined region in a form of a pop-up on a predetermined region of the display unit 110 based on the article history/article relevant information.

Here, the article history/article relevant information is information separately provided from the content service server 200, differently from the additional information provided in connection with the video content reproduced in the terminal device 100. The article history/article relevant information contains at least one of the user identification information (e.g., an ID/password for the content service server 200, a user identification number, and the like), at least one tagging information, the article information indicating the article registered in connection with each tagging information (e.g., registered web service server information and article identification information), additional comment input information corresponding to each article information (e.g., additional comment information, for example, a title of the additional comment and contents of the additional comment), and additional comment writer information (e.g., an ID of a writer and additional comment written time information).

Accordingly, in the method of using the content service by the terminal device 100 according to the present disclosure, when the article history/article relevant information is provided from the content service server 200, the additional comment summary information may be displayed on the predetermined region based on the information contained in the article history/article relevant information.

Here, the additional comment summary information may contain the number of pieces of additional comment input information (e.g., three questions 1 and one question 3) on each of the user comments (e.g., question 1 and question 3) contained in each of at least one tagging information, and brief information (e.g., titles of additional comments 1, 2, 3, and 4, and corresponding web service server information on the additional comment) on each additional comment input information. Accordingly, the user may recognize a name of a web service (e.g., Q&A of Naver and Community of Google) in which the additional comment is written on the comments of the user and a summary of the additional comment (e.g., a title of the additional comment) through the additional comment summary information displayed in the terminal device 100.

Accordingly, in the method of using the content service by the terminal device 100 according to the present disclosure, when specific brief information (e.g., a title of additional comment 1) is selected from the additional comment summary information according to the user operation so that a detailed information view is selected (S173), detailed contents corresponding to the selected brief information (e.g., the title of additional comment 1) may be displayed on the predetermined region (S176).

That is, in the method of using the content service by the terminal device 100 according to the present disclosure, the detailed contents containing the user comment (e.g., question 1) contained in the corresponding tagging information within the article history/article relevant information corresponding to the selected brief information (e.g., the title of additional comment 1), the corresponding scene image (in a state of the selected area designation), the additional comment information contained in the additional comment input information within the corresponding article history/article relevant information (e.g., the title of additional comment 1 and contents of additional comment 1), writer information on additional comment 1 (e.g., an ID of the writer), and information on a written time of additional comment 1 may be displayed (S176).

Otherwise, in the method of using the content service by the terminal device 100 according to the present disclosure, the access to the corresponding article may be allowed by accessing the corresponding web service server based on the article information (e.g., (e.g., the information on the web service server in which the article is registered and the article identification information) contained in the article history/article relevant information corresponding to the selected brief information (e.g. the title of additional comment 1).

Accordingly, in the method of using the content service by the terminal device 100 according to the present disclosure, when the user of the terminal device 100 reproducing/watching the video content inputs the user comment (e.g., a question) on the selected area (the image area or the specific reproduction section of the specific scene), the tagging information according to the input user comment is generated and the generated tagging information is provided to the corresponding content service server 200, thereby enabling the content service server 200 to automatically register the corresponding article in the web service based on the tagging information, and the additional comment summary information and/or the detailed contents are displayed based on the article history/article relevant information of the user according to the input of additional comments (e.g., replies) by many unspecified users reading the article by using the web service, thereby enabling the user to rapidly and conveniently check the additional comments (e.g., the replies) on the user comment, i.e., the article, input by the user himself/herself.

In the meantime, when it is determined that the tagging input is not selected in step S160, in the method of using the content service by the terminal device 100 according to the present disclosure, it is determined whether a tagging information view for the specific position of the progress bar displayed together with the reproduced video content (e.g., movie 2) is selected (S180).

In the method of using the content service by the terminal device 100 according to the present disclosure, when the tagging information view is not selected as a result of the determination, the video content may be continuously reproduced (S185).

However, in the method of using the content service by the terminal device 100 according to the present disclosure, when the tagging information view for the specific position of the progress bar is selected as a result of the determination, the user comment may be displayed based on at least one tagging information corresponding to the reproduction time of the selected specific position of the progress bar on a basis of the additional information on the video content (e.g., movie 2) (S190).

That is, in the method of using the content service by the terminal device 100 according to the present disclosure, when the user, who recognizes the existence of the tagging information in the specific position through the displayed progress bar, selects the tagging information view for the specific position, at least one tagging information corresponding to the specific position for which the tagging information view is selected is extracted and the user comment (e.g., advertisement 1, question 2, and relevant URL 3) contained in each of the extracted tagging information is displayed based on the additional information on the video content (e.g., the broadcast or movie 2).

Accordingly, the user may identify the displayed user comment. In this case, in the method of using the content service by the terminal device 100 according to the present disclosure, when the scene image is included in the extracted tagging information, the corresponding scene image (in a state of the selected area designation) may be displayed together with the user comment (e.g., advertisement 1, question 2, and relevant URL 3).

Here, in the method of using the content service by the terminal device 100 according to the present disclosure, when the user selects the displayed specific user comment (e.g., relevant URL 3), the relevant URL 3 may be transferred to another function unit (e.g., the web communication controller (not shown)) within the terminal device 100 and thus the web communication controller (not shown) may be allowed to access the relevant URL 3.

Further, in the method of using the content service by the terminal device 100 according to the present disclosure, when the user selects the displayed specific user comment (e.g., question 2), detailed contents (e.g., entire contents of the question and at least one reply to the question) of the selected user comment (e.g., question 2) may be displayed based on the corresponding tagging information.

Hereinafter, a method of providing a content service by the content service server 200 according to the present disclosure will be described with reference to FIG. 6.

In the method of providing the content service by the content service server 200 according to the present disclosure, predetermined tagging information is received from the external terminal device 100 (S210).

Here, the tagging information provided from the terminal device 100 contains at least one of a user comment, information on a corresponding video content in which the user comment is input, scene image information including a reproduction time of a scene image in which the user comment is input, selected area information indicating a selected area designated in the scene image, selected area information indicating a selected area corresponding to a reproduction section in which the user comment is input, and posting request information containing at least one of information on a predetermined web service server, log-in related information, and information on selection of publication or non-publication.

Then, in the method of providing the content service by the content service server 200 according to the present disclosure, additional information on the corresponding video content is generated/managed based on the received tagging information (S220).

That is, in the method of providing the content service by the content service server 200 according to the present disclosure, the additional information on the corresponding video content is generated/managed based on the tagging information, i.e., the received tagging information containing at least one of the user comment, the information on the corresponding video content in which the user comment is input, the scene image information including the reproduction time of the scene image in which the user comment is input, the selected area information indicating the selected area designated in the scene image, the selected area information indicating the selected area corresponding to the reproduction section in which the user comment is input, and the posting request information containing at least one of the information on the predetermined web service server, the log-in related information, and the information on the selection of the publication or non-publication.

In the meantime, in the method of providing the content service by the content service server 200 according to the present disclosure, an article corresponding to the tagging information is registered in at least one corresponding web service server 300 based on the received tagging information.

More particularly, in the method of providing the content service by the content service server 200 according to the present disclosure, when the tagging information is received from the terminal device 100, the posting request information is extracted/recognized from the received tagging information (S230).

The extracted/recognized posting request information may contain the web service server information (e.g., a server access address) on the web service (e.g., a Q&A service, a community service, and a blog service) designated/requested to register/post the user comment included in the tagging information, the log-in relevant information including a log-in ID/password of the user registered in the corresponding web service server, and the information on the selection of the publication or non-publication designating/requesting the publication or the non-publication (e.g., publication/non-publication to many unspecified users, publication/non-publication to acquaintances, publication only to the user himself/herself, etc.) of the article corresponding to the input user comment and the publication or the non-publication (e.g., publication/non-publication to many unspecified users, publication/non-publication to acquaintances, publication only to the user himself/herself, etc.) of the additional comment input in connection with the corresponding article.

Accordingly, in the method of providing the content service by the content service server 200 according to the present disclosure, the article corresponding to the received tagging information may be registered in the corresponding web service server 300 based on the posting request information extracted/recognized from the received tagging information (S240).

That is, in the method of providing the content service by the content service server 200 according to the present disclosure, the article may be registered by accessing the corresponding web service server 300 based on the posting request information, performing a log-in process based on the ID/password of the corresponding user by using the log-in relevant information, generating and registering the article containing at least one of the predetermined user comment (e.g., question 1) contained in the tagging information, the information on the corresponding video content (e.g. video content identification information, URL information on the video content) in which the user comment is input, the scene image information (e.g., the reproduction time information and the scene image) including the reproduction time of the scene image in which the user comment (e.g., question 1) is input, the selected area information indicating the selected area designated in the scene image (e.g., the information on a position within the scene image), and the selected area information (e.g., time information on the reproduction section: 15 min. 00 sec. to 30 min. 00 sec. and a video of the reproduction section) indicating the selected area corresponding to the reproduction section (e.g., 15 min. 00 sec. to 30 min. 00 sec. of the reproduction time) in which the user comment is input, and setting an item for the publication or the non-publication of the registered article and/or the additional comment registered in connection with the registered article according to the information on the selection of the publication or non-publication.

In the meantime, in the method of providing the content service by the content service server 200 according to the present disclosure, the posting request information containing at least one of web service server information, log-in information, and information on selection of publication or non-publication for a web service to which a request for posting of the user comment contained in the tagging information is made may be received for registration, and stored/managed for each user (S200).

That is, in the method of providing the content service by the content service server 200 according to the present disclosure, the posting request information is registered and managed for each user, and each posting request information may contain the web service server information (e.g., a server access address) on the web service (e.g., a Q&A service, a community service, and a blog service) designated/requested to register/post the user comment included in the tagging information, the log-in relevant information including a log-in ID/password of the user registered in the corresponding web service server, and the information on the selection of the publication or non-publication designating/requesting the publication or the non-publication (e.g., publication/non-publication to many unspecified users, publication/non-publication to acquaintances, publication only to the user himself/herself, etc.) of the article corresponding to the input user comment and the publication or the non-publication (e.g., publication/non-publication to many unspecified users, publication/non-publication to acquaintances, publication only to the user himself/herself, etc.) of the additional comment input in connection with the corresponding article.

In this case, in the method of providing the content service by the content service server 200 according to the present disclosure, aforementioned step S230 is not performed, and the article corresponding to the tagging information may be registered in the corresponding web service server 300 based on the posting request information on the user corresponding to the received tagging information in step S240 (S240).

That is, in the method of providing the content service by the content service server 200 according to the present disclosure, the article may be registered by accessing the corresponding web service server 300 based on the posting request information, performing a log-in process based on the ID/password of the corresponding user by using the log-in relevant information, generating and registering the article including at least one of the predetermined user comment (e.g., question 1) contained in the tagging information, information on the corresponding video content (e.g. video content identification information and URL information on the video content) in which the user comment is input, the scene image information (e.g., the reproduction time information and the scene image) including the reproduction time of the scene image in which the user comment (e.g., question 1) is input, the selected area information indicating the selected area designated in the scene image (e.g., the information on a position within the scene image), and the selected area information (e.g., time information on the reproduction section: 15 min. 00 sec. to 30 min. 00 sec. and a video of the reproduction section) indicating the selected area corresponding to the reproduction section (e.g., 15 min. 00 sec. to 30 min. 00 sec. of the reproduction time) in which the user comment is input, and setting an item for the publication or the non-publication of the registered article and/or the additional comment registered in connection with the registered article according to the information on the selection of the publication or non-publication.

Accordingly, the article registered by the ID of the user logged-in to the web service server 300 through the method of providing the content service by the content service server 200 according to the present disclosure includes the user comment (e.g., question 1) and at least one of the scene image (in a state of the selected area designation) or the video in connection with the corresponding reproduction section in which the user comment (e.g., question 1) is input, and when the corresponding video content is a free content or when an excerpt of the corresponding video content is permitted by a content owner in advance, the article may include URL information on the video content so as to partially or entirely reproduce the corresponding video content (a form of a plug-in player).

It is a matter of course that, in the method of providing the content service by the content service server 200 according to the present disclosure, when the article according to the tagging information is registered in the web service server 300, various interactive services, such as a link to a relevant advertisement or a commerce site, may be simultaneously provided.

Accordingly, many unspecified users capable of reading the article by accessing the web service server 300 may read the article corresponding to the user comment (e.g., question 1) on the specific selected area input during a time when the user of the terminal device 100 watches the video through his/her terminal device 100, check the article by reproducing a part/an entirety of the video content related to the article, and input their additional comments (e.g., replies) on the article.

Further, in the method of providing the content service by the content service server 200 according to the present disclosure, article history/article relevant information on the article registered in connection with the tagging information is preferably generated/managed for each user (S250).

That is, in the method of providing the content service by the content service server 200 according to the present disclosure, the article history/article relevant information is managed for each user, and the article history/article relevant information contains at least one of user identification information (e.g., an ID/password for the content service server 200, a user identification number, and the like), at least one tagging information provided in connection with the corresponding user, article information indicating the article registered in connection with each tagging information (e.g., registered web service server information, article identification information, and the like), additional comment input information corresponding to each article information (e.g., additional comment information, for example, a title of the additional comment and contents of the additional comment), and additional comment writer information (e.g., an ID of a writer and additional comment written time information).

Accordingly, in the method of providing the content service by the content service server 200 according to the present disclosure, when the article is registered in the web service server 300 based on the received tagging information, the article history/article relevant information in connection with the corresponding user is updated.

Further, in the method of providing the content service by the content service server 200 according to the present disclosure, it is determined whether predetermined additional comment input information is received from the web service server 300 in connection with the article registered in at least one web service server 300 (S260), and when the additional comment input information is received, the article history/article relevant information in connection with the corresponding user is updated based on the additional comment input information (S270).

Here, the additional comment input information provided from the web service server 300 may contain the article information containing the article identification information on the corresponding article on which the additional comment is input and the web service server information indicating the web service server 300 itself, information on a writer who inputs the additional comment (e.g., an ID of a writer), the additional comment written time information, and the additional comment information (e.g., a title of the additional comment and contents of the additional comment).

Accordingly, in the method of providing the content service by the content service server 200 according to the present disclosure, the article history/article relevant information in connection with the corresponding user containing the corresponding article identification information may be updated based on the additional comment input information provided from the web service server 300.

In this case, in the method of providing the content service by the content service server 200 according to the present disclosure, the additional information on the corresponding video content is generated/managed based on the additional comment input information on the predetermined article, i.e., the additional comment input information containing at least one of the article information (e.g., the article identification information and the web service server information), the information on the writer who inputs the additional comment (e.g., the ID of the writer), the additional comment written time information, and the additional comment information (e.g., the title of the additional comment and the contents of the additional comment), received from the web service server 300.

In the method of providing the content service by the content service server 200 according to the present disclosure, the video content corresponding to the article identification information contained in the additional comment input information may be recognized based on the article history/article relevant information, and thus in the method of providing the content service by the content service server 200 according to the present disclosure, the additional information on the corresponding video content may be generated/managed based on the additional comment input information.

Accordingly the additional information on each video content managed by the method of providing the content service by the content service server 200 according to the present disclosure is generated based on at least one tagging information pre-provided from multiple users who reproduce/watch the corresponding video content (e.g., movie 2), i.e. the tagging information on various selected areas (e.g., image areas of specific scenes or specific reproduction sections) pre-provided from multiple users for the corresponding video content (e.g., movie 2), and the additional comment input information corresponding to additional comments (e.g., replies) of many unspecified users reading the article corresponding to the tagging information. The additional information may be meta information on the video content.

Further, in the method of providing the content service by the content service server 200 according to the present disclosure, it is determined whether the connected terminal device 100 of the corresponding user is in an accessing state upon the update of the article history/article relevant information in connection with the corresponding user according to the reception of the additional comment input information from the web service server 300 (S280), and when the connected terminal device 100 of the corresponding user is in the accessing state, the article history/article relevant information in connection with the corresponding user is provided to the terminal device 100 and additional comment summary information according to the article history/article relevant information may be displayed (S300).

Otherwise, in the method of providing the content service by the content service server 200 according to the present disclosure, it is determined whether the terminal device 100 of a predetermined user accesses (S290), and when the terminal device 100 corresponding to the predetermined user is connected, the article history/article relevant information in connection with the corresponding user is provided to the terminal device 100 and additional comment summary information according to the article history/article relevant information may be displayed (S300).

Further, in the method of providing the content service by the content service server 200 according to the present disclosure, when a predetermined video content is requested from the terminal device 100, additional information generated/managed in connection with the requested video content may be provided to the terminal device 100.

For example, in the method of providing the content service by the content service server 200 according to the present disclosure, in a case where the content service server 200 performs only an additional information management function, when the terminal device 100 makes a request for the video content (e.g., movie 2) to a separate content providing server (not shown), the content service server 200 may recognize the request for the video content (e.g., movie 2) by the terminal device 100 and provide the terminal device 100 with the additional information generated/managed in connection with the requested video content (e.g., movie 2) while interworking with the content providing server (not shown).

Otherwise, in the method of providing the content service by the content service server 200 according to the present disclosure, in a case where the content service server 200 performs a video content providing function, as well as the additional information management function, when the terminal device 100 makes a request for the video content (e.g., movie 2) to the content service server 200, the content provider 230 may provide the terminal device 100 with the pre-possessed video content (e.g., movie 2) together with the additional information generated/managed in connection with the video content (e.g., movie 2).

As described above, the content service method according to the present disclosure provides an environment allowing the user of the terminal device 100 reproducing/watching the video content to easily and freely input the user comment on the specific selected area (e.g., the image area or the specific reproduction section of the specific scene), and generates the tagging information on the input user comment and provides the corresponding content service server 200 with the generated tagging information, to make the content service server 200 automatically register the article to the web service based on the tagging information, thereby being capable of enabling the user to acquire/check additional comments, such as responses and opinions, on the user comment of the user of the terminal device 100 from a group of many unspecified intelligent users who use the web service through the terminal device 100 and effectively generating/managing the additional information on respective video contents based on the tagging information and the additional comment input information according to the additional comments from the terminal devices 100 of the many unspecified users.

Accordingly, the content service method according to the present disclosure enables the user of the terminal device 100 to acquire/check additional comments, such as responses and opinions, on the user comment on the specific selected area (e.g., the image area or the specific reproduction section of the specific scene) of the video input by the user of the terminal device 100 from the group of many unspecified intelligent users who use the web service through the terminal device 100, thereby being capable of supporting the acquisition of detailed and broad information for the user, and effectively generates/manages the additional information on respective video contents based on the user comments provided in connection with the respective video contents from the terminal devices 100 of many unspecified users and the additional comments of a group of many unspecified intelligent users on the article, thereby being capable of effectively generating/managing more detailed and various additional information on the video by the many unspecified users and providing the detailed and various additional information to another user.

Although the exemplary embodiment of the present disclosure has been described in detail, the present disclosure is not limited to the exemplary embodiment, and those skilled in the art to which the present disclosure pertains will appreciate that various changes or modification without departing from the scope of the present disclosure equivalent to the claims belong to the technical spirit of the present disclosure.

When the content service method and system, in which a user reproducing/watching a video content can easily and freely input a user comment on an image area or a specific reproduction section of a specific scene and a corresponding article is automatically registered/posted to a web service based on the tagging information according to the input user comment, so that the user can acquire desired additional comments, such as responses and opinions, from a group of many unspecified intelligent users who use the web service and further more detailed and various additional information on the video can be effectively generated/managed by generating/managing additional information on each video content based on user comments and additional comments on the user comments on an image region or a specific reproduction section of a specific scene by many unspecified users, is applied, variety and efficiency of content information exchange, a content service quality, and user satisfaction on a content service will be advanced a great deal and a possibility that the applied terminal device, content service server, and service solution will come onto the market or be traded is sufficient and will be realistically and obviously implemented as well.

What is claimed is:

1. A method for providing a content service by a content service server, the method comprising:
obtaining tagging information about a content including at least one of section, wherein the tagging information includes identifier of a content, time information and location information of the at least one section;
generating additional information of the content based on the obtained tagging information; and
transmitting the additional information of the content to a terminal,
wherein the at least one section of the content is played out in the terminal based on the additional information.

2. The method of claim 1, wherein the location information includes URL of the at least one section.

3. The method of claim 1, further comprises:
obtaining additional input information related to the content; and
updating the additional information based on the obtained additional input information,
wherein the additional input information includes time information and location information of an article related to the content.

4. The method of claim 1, further comprises:
receiving a request for the additional information from the terminal.

5. The method of claim 1, further comprises:
transmitting at least one section of the content to the terminal.
